(19) United States
(12) Patent Application Publication
(10) Pub. No.: US 2017/0230668 A1
(43) Pub. Date: Aug. 10, 2017

(54) Method and Apparatus of Mode Information Reference for 360-Degree VR Video

(71) Applicant: MEDIATEK INC., Hsin-Chu (TW)

(72) Inventors: Hung-Chih LIN, Caotun Township (TW); Shen-Kai CHANG, Zhubei City (TW)

(21) Appl. No.: 15/418,931

(22) Filed: Jan. 30, 2017

Related U.S. Application Data
(60) Provisional application No. 62/291,592, filed on Feb. 5, 2016.

(51) Int. Cl. H04N 19/159; H04N 19/174; H04N 19/513; H04N 19/184; H04N 19/176

(52) U.S. Cl. CPC H04N 19/159; H04N 19/184; H04N 19/176; H04N 19/513; H04N 19/174

(57) ABSTRACT

Method and apparatus of video coding for a spherical frame sequence or a cubic frame sequence in a video encoder or decoder are disclosed. According to one method, surrounding blocks for a current block are identified and any surrounding block outside a vertical spherical frame boundary or outside a cubic face boundary of a current cubic face is mapped to a remapped surrounding block. One or more available remapped surrounding blocks for the current block are determined. Mode information reference is generated using mode information associated with said one or more available remapped surrounding blocks. The mode information associated with the current block is then used for encoding or decoding the mode information of the current block. In another method, Intra prediction pixels are determined from the available remapped surrounding blocks. The Intra prediction pixels are used for Intra prediction encoding or decoding of the current block.

### CROSS REFERENCE TO RELATED APPLICATIONS

The present invention claims priority to U.S. Provisional Patent Application, Ser. No. 62/291,592, filed on Feb. 5, 2016. The U.S. Provisional patent application is hereby incorporated by reference in its entirety.

### FIELD OF THE INVENTION

The present invention relates to image and video coding. In particular, the present invention relates to techniques of Intra prediction and Inter prediction for a sequence of spherical images and a sequence of cubic images converted from the spherical images.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a set of cameras, arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

FIG. 1 illustrates an exemplary processing chain for 360-degree spherical panoramic frames. The 360-degree spherical panoramic frames may be captured using a 360-degree spherical panoramic camera. Spherical frame processing unit 110 accepts the raw image data from the camera to form a sequence of 360-degree spherical panoramic images. The spherical image processing may include image stitching and camera calibration. The spherical image processing is known in the field and the details are omitted in this disclosure. The conversion can be performed by a projection conversion unit 120 to derive the six-face cubic frame corresponding to the six faces of a cube. Since the 360-degree image sequences may require large storage space or require high bandwidth for transmission, video encoding by a conventional video encoder 130 may be applied to the image sequence to reduce required storage or transmission bandwidth. The conventional video encoder uses Intra/Inter prediction to compress the input video data. The system shown in FIG. 1 may represent a video compression system for spherical image sequence (i.e., Switch at position A). The system shown in FIG. 1 may also represent a video compression system for cubic image sequence (i.e., Switch at position B). At a receiver side or display side, the compressed video data is decoded using a video decoder 140 to recover the sequence of spherical image or cubic image (or cubic faces) for display on a display device 150 (e.g. a VR (virtual reality) display). The decoder uses Intra/Inter prediction to reconstruct the video sequence.

Since the data related to 360-degree spherical frames and cubic frames usually are much larger than conventional two-dimensional video, video compression is desirable to reduce the required storage or transmission. Accordingly, in a conventional system, regular video encoding 130 and regular decoding 140 such as H.264 or the newer HEVC (High Efficiency Video Coding) may be used. The conventional video coding treats the spherical frames and the cubic frames as frames captured by a conventional video camera disregarding the unique characteristics of the underlying the spherical frames and the cubic frames as frames.

In conventional video coding systems, Intra prediction and Inter prediction are often used adaptively to achieve high compression efficiency. For Intra prediction, the current bock can use reconstructed pixels located at neighboring blocks in the same frame as reference data to derive Intra predictors. For Inter prediction, the reconstructed pixels in one or two reference frames can be used to derive one or two prediction blocks for the current block. In the encoder side, motion estimation (ME) is used to determine one or two reference blocks that achieve the minimum Rate-Distortion cost or the minimum distortion. Motion compensation (MC) is performed to identify the reference block(s). The reference block(s) is used to generate Inter-prediction residues at the encoder side and is used with decoded residues to generate the reconstructed block at the decoder side. Usually, the processes of motion estimation (ME) and motion compensation (MC) perform the replication padding that repeats the frame boundary pixels when the selected reference block is outside or crossing frame boundary of the reference frame. Unlike the conventional 2D video, a 360-degree video is an image sequence representing the whole environment around the captured cameras. Although the two commonly used projection formats, spherical and cubic formats, can be arranged into a rectangular frame, geometrically there is no boundary in a 360-degree frame.

Since the conventional video coding ignores the fact of content continuity in the spherical frames or cubic frames. The information is useful and should be able to improve compression efficiency. Accordingly, new Intra-prediction and Inter-prediction techniques are disclosed to improve the compression efficiency for spherical image sequences and cubic image sequences.

### BRIEF SUMMARY OF THE INVENTION

Method and apparatus of video encoding or decoding for a spherical image sequence or a cubic image sequence in a video encoder or decoder respectively are disclosed. According to one method, input data associated with a current image unit in a spherical image sequence or a cubic image sequence are received at an encoder side, or a bitstream comprising compressed data including the current image unit is received at a decoder side, wherein each spherical frame in the spherical image sequence corresponds to a 360-degree panoramic picture and each cubic frame in the cubic image sequence is generated by unfolding each set of six cubic faces on a cube. Surrounding blocks for a current block in the current image unit to be encoded at the encoder side or to be decoded at the decoder side are determined. Any surrounding block outside spherical frame boundary or outside a cubic face boundary of a current cubic face is mapped to a remapped surrounding block in other part of the spherical frame at another spherical frame boundary or in a connected cubic face in the cubic frame according to content continuity of each spherical frame or each cubic frame, wherein the remapped surrounding block for any surrounding block inside spherical frame boundary or inside the cubic face boundary is itself. One or more available remapped surrounding blocks for the current block are determined, wherein said one or more available remapped surrounding blocks correspond to one or more remapped surrounding blocks that are encoded or decoded prior to the current block. Mode information reference is generated using mode information including the mode information associated with said one or more available remapped surrounding blocks, wherein the mode information is associated with Intra prediction or Inter prediction applied to the current block or said one or more available remapped surrounding blocks. The mode information associated with the current block is encoded into compressed bits associated with the current block using the mode information reference at the encoder side, or the mode information associated with the current block is decoded, from compressed bits associated with the current block, using the mode information reference and the current block is further reconstructed according to the mode information associated with the current block at the decoder side. The bitstream comprising compressed bits associated with the current block is outputted at the encoder side or a reconstructed image unit including the reconstructed current block is outputted at the decoder side. The current image unit may correspond to a slice.

When the current block is located at a left frame boundary of a spherical frame, one or more surrounding blocks to a left edge of the current block are horizontally mapped to a right frame boundary of the spherical frame. When the current block is located at a right frame boundary of a spherical frame, one or more surrounding blocks to a right edge of the current block are horizontally mapped to a left frame boundary of the spherical frame. When the current block is located at a current cubic face boundary of a cubic frame, one or more surrounding blocks outside the cubic face are circularly mapped to one or more connected cubic faces, wherein each connected cubic face is connected to the current cubic face at a common circular edge having a same circular edge labelling.

If the mode information is associated with the Intra prediction applied to the current block or said one or more available remapped surrounding blocks, the mode information reference corresponds to most probable modes (MPM). If the mode information is associated with the Inter prediction applied to the current block or said one or more available remapped surrounding blocks, the mode information reference corresponds to motion vector prediction (MVP). For Inter prediction, the mode information may include motion vector, reference picture list, reference picture index or a combination thereof. Said one or more available remapped surrounding blocks can be used as spatial neighboring blocks and co-located blocks of one or more unavailable remapped surrounding blocks can be used as temporal neighboring blocks for deriving the MVP. An MVP candidate list can be generated using motion information associated with the spatial neighboring blocks and the temporal neighboring blocks.

A method and apparatus of selecting prediction pixels for Intra prediction of spherical frames or cubic frames are also disclosed. The processes of determining surrounding blocks, remapping surrounding blocks outside spherical frame boundary or outside a cubic face boundary of a current cubic face and determining available remapped surrounding blocks are similar to the above method. After the available remapped surrounding blocks are determined, generating current Intra predictors using pixels from said one or more available remapped surrounding blocks. The current Intra predictors generated are then used to encode or decode the current block using Intra prediction.

### BRIEF DESCRIPTION OF THE DRAWINGS

FIG. 1 illustrates an exemplary processing chain for 360-degree spherical panoramic frames.

FIG. 2A illustrates examples of numbering of the cubic faces, where the cube has six faces, three faces are visible and the other three faces are invisible since they are on the back side of the cube.

FIG. 2B illustrates an example corresponding to an unfolded cubic image generated by unfolding the six faces of the cube, where the numbers refer to their respective locations and orientations on the cube.

FIG. 2C illustrates an example corresponding to an assembled cubic-face image without blank areas.

FIG. 3 illustrates an exemplary implementation of the 360° VR-Aware Intra/Inter Prediction for spherical image sequence or cubic image sequence, where mode information reference is generated and used for encoding and decoding.

FIG. 4 illustrates the 11 distinct cubic nets for unfolding the six cubic faces of a cube, where cube face number 1 is indicated in each cubic net.

FIG. 5A illustrates an example of a block X located at the left frame boundary, where the surrounding blocks to the left of the left edge of block X are outside the left vertical frame boundary.

FIG. 5B illustrates an example of a block X located at the left frame boundary and the surrounding blocks to the left of the left edge of block X can be mapped to locations at the right vertical frame boundary.

FIG. 6A illustrates an example of a block X located at the right frame boundary, where the surrounding blocks to the right of the right edge of block X are outside the right vertical frame boundary.

FIG. 6B illustrates an example of a block X located at the right frame boundary and the surrounding blocks to the right of the right edge of block X can be mapped to locations at the left vertical frame boundary.

FIG. 7A illustrates an example of selecting Intra prediction pixels according an embodiment of the present invention for block X in FIG. 5B.

FIG. 7B illustrates an example of selecting Intra prediction pixels according an embodiment of the present invention for block X in FIG. 6B.

FIG. 8A illustrates an example of deriving mode information reference based on available remapped surrounding blocks for Intra prediction according an embodiment of the present invention for block X in FIG. 5B.

FIG. 8B illustrates an example of deriving mode information reference based on available remapped surrounding blocks for Intra prediction according an embodiment of the present invention for block X in FIG. 6B.

FIG. 9A illustrates an example of neighboring blocks used to derive mode information for block X at the left edge of the current frame as shown in FIG. 5B.

FIG. 9B illustrates an example of neighboring blocks used to derive mode information for block X at the right edge of the current frame as shown in FIG. 6B.

FIG. 10 illustrates examples of the circular edge labeling of the six cubic faces for a cubic frame corresponding to a cubic net with blank areas filled with padding data and an assembled 1×6 cubic-face frame.

FIG. 11 illustrates an example of surround blocks for block X located at the edge (i.e., edge #5) of a cubic face (i.e., cubic face 6) of an unfolded cubic frame with blank areas, where blocks A through H are surrounding blocks of block X.

FIG. 12 illustrates an example of remapping surround blocks outside a cubic face according to an embodiment of the present invention for block X located at the edge (i.e., edge #5) of the cubic face (i.e., cubic face 6) of an unfolded cubic frame with blank areas.

FIG. 13 illustrates an example of surround blocks for block X located at the edge (i.e., edge #3 and edge #6) of a cubic face (i.e., cubic face 2) of an assembled cubic frame without blank areas, where blocks A through H are surrounding blocks of block X.

FIG. 14 illustrates an example of remapping surround blocks outside a cubic face according to an embodiment of the present invention for block X located at the edge (i.e., edge #3 and edge #6) of a cubic face (i.e., cubic face 2) of an assembled cubic frame without blank areas.

FIG. 15A illustrates an example of collecting the prediction pixels from the available remapped surrounding blocks to generate predictors for Intra prediction according an embodiment of the present inventor for block X in FIG. 12.

FIG. 15B illustrates an example of collecting the prediction pixels from the available remapped surrounding blocks to generate predictors for Intra prediction according an embodiment of the present inventor for block X in FIG. 14.

FIG. 16A illustrates an example of deriving mode information reference based on mode information of the available remapped surrounding blocks for Intra prediction according an embodiment of the present inventor for block X in FIG. 12.

FIG. 16B illustrates an example of deriving mode information reference based on mode information of the available remapped surrounding blocks for Intra prediction according an embodiment of the present inventor for block X in FIG. 14.

FIG. 17A illustrates an example of deriving mode information reference based on mode information of the available remapped surrounding blocks for Inter prediction according an embodiment of the present inventor for block X in FIG. 12.

FIG. 17B illustrates an example of deriving mode information reference based on mode information of the available remapped surrounding blocks for Inter prediction according an embodiment of the present inventor for block X in FIG. 14.

FIG. 18 illustrates an exemplary flowchart video encoding or decoding for a spherical image sequence or a cubic image sequence in a video encoder or decoder respectively using mode information reference according to an embodiment of the present invention.

FIG. 19 illustrates an exemplary flowchart video encoding or decoding for a spherical image sequence or a cubic image sequence in a video encoder or decoder respectively according to an embodiment of the present invention, where surrounding blocks are remapped to take into consideration of continuity for collecting Intra prediction pixels in Intra prediction.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the conventional video coding treats the spherical image sequence and the cubic image sequence as regular frames from a regular video camera. When Intra prediction is used, the previously neighboring reconstructed blocks for a current block may be used. A conventional coding system would treat these previously neighboring reconstructed blocks as unavailable if they are outside frame boundary. When Inter prediction is applied, a reference block in a reference frame is identified and used as a temporal predictor for the current block. Usually, a pre-determined search window in the reference frame is searched to find a best matched block. The search window may cover an area outside the reference frame, especially for a current block close to the frame boundary. When the search area is outside the reference frame, the motion estimation is not performed or pixel data outside the reference frame is generated artificially in order to apply motion estimation. In conventional video coding systems, such as H.264 and HEVC, the pixel data outside the reference frame are generated by repeating boundary pixels. These conventional coding systems ignore the content-continuity feature within the frames from 360-degree VR video.

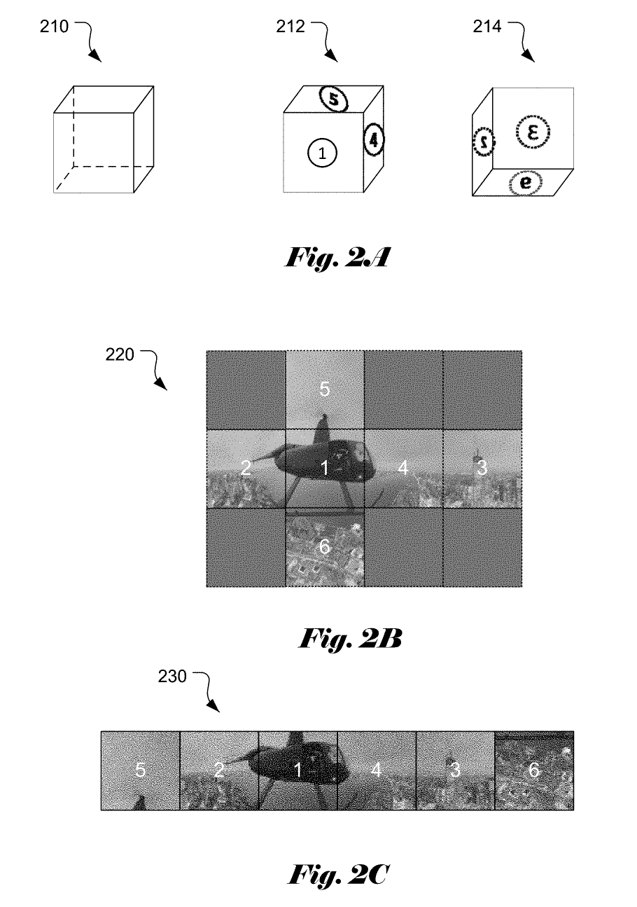

As mention before, since the 360-degree panorama camera captures scenes all around, the stitched spherical frame is continuous in the horizontal direction. That is, the contents of the spherical frame at the left vertical boundary continue to the right vertical boundary. The spherical frame can also be projected to the six faces of a cube as an alternative 360-degree format. The conversion can be performed by projection conversion to derive the six-face frame representing the six faces of a cube. On the faces of the cube, these six faces are connected at the edges of the cube. FIG. 2A to FIG. 2C illustrate examples of cubic faces. In FIG. 2A, the cube 210 has six faces. The three visible faces, labelled as 1, 4 and 5, are shown in the middle illustration 212, where the orientation of the numbers (i.e., “1”, “4” and “5”) indicates the cubic faces orientation. There are also three cubic faces being blocked and invisible from the front side as shown by illustration 214. The three blocked cubic faces are labelled as 2, 3 and 6, where the orientation of the numbers (i.e., “2”, “3” and “6”) indicates the cubic face orientation. These three numbers enclosed in dashed circle for the invisible cubic faces indicate the see-through frames since they are on the back sides of the cube. Cubic faces 220 in FIG. 2B corresponds to an unfolded cubic frame with blank areas filled with padding data, where the numbers refer to their respective locations and orientations on the cube. As shown in FIG. 2B, the unfolded cubic faces are fitted into a smallest rectangular frame that covers the six unfolded cubic faces. Frame 230 in FIG. 2C corresponds to an assembled rectangular frame without any blank area, where the assembled frame is composed of 1×6 cubic faces. The picture in FIG. 2B as a whole is referred as a cubic frame in this disclosure. Also, the picture in FIG. 2C as a whole is referred as a cubic frame in this disclosure.

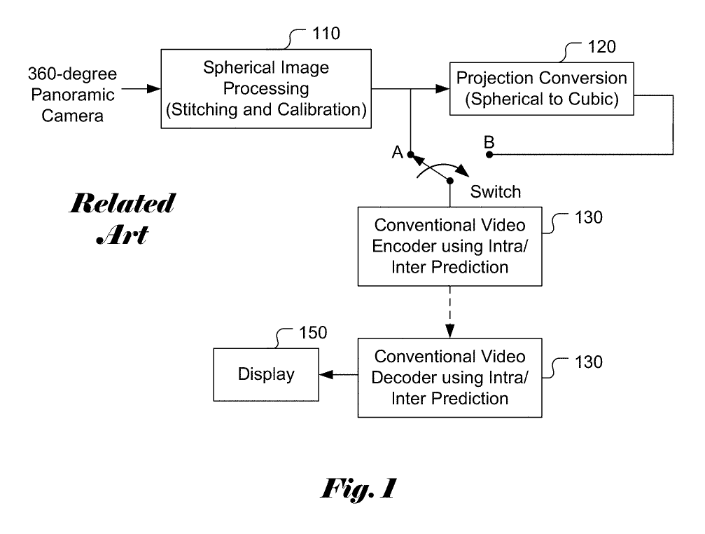

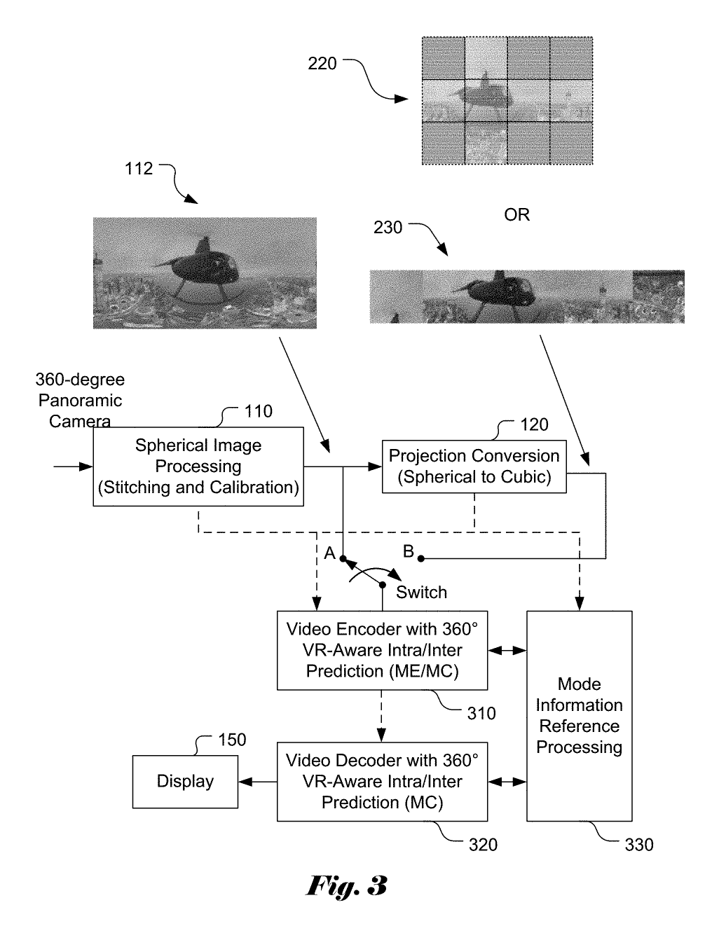

In order to take advantage of the horizontal continuity of the spherical frame and the continuity between some cubic-face images of the cubic frame, the present invention discloses 360° VR-Aware Intra/Inter Prediction to exploit the horizontal continuity of the spherical frame and the continuity between some cubic-face images of the cubic frame. An exemplary implementation of the 360° VR-Aware Intra/Inter Prediction for spherical image sequence or cubic image sequence is shown in FIG. 3, where the conventional video encoder 130 and conventional video decoder 140 in FIG. 1 are replaced by video encoder with 360° VR-Aware Intra/Inter Prediction ME/MC 310 and video decoder with 360° VR-Aware Intra/Inter Prediction MC 320 according to embodiments of the present invention. In the video encoder 310, the 360° VR-Aware Intra/Inter Prediction is used for the derivation of the Intra MPM, the generation of intra-predicted blocks, motion estimation (ME), and motion compensation (MC). In the video decoder 320, the 360° VR-Aware Intra/Inter Prediction is used for the derivation of the Intra MPM, the generation of intra-predicted blocks, and motion compensation (MC). In particular, FIG. 3 includes Mode Information Reference Processing unit 330 that provides mode information reference to the encoder 310 and decoder 320. The mode information can be used for predicting or coding the mode information for a current block, such as MPM for Intra prediction and MVP for Inter prediction, or generating predictors for Intra prediction. The details will be disclosed in later parts of this disclosure.

For convenience, system block diagram in FIG. 3 is intended to illustrate two types of the system structure: one for compression of spherical frame system and one for the cubic image sequence. For a system to encode an image sequence with a known format (either the spherical image sequence or the cubic image sequence), the Switch does not exist. Furthermore, the cubic frame may correspond to the unfolded cubic frames with blank areas filled with padding data (220) or the assembled rectangular frame without any blank area (230).

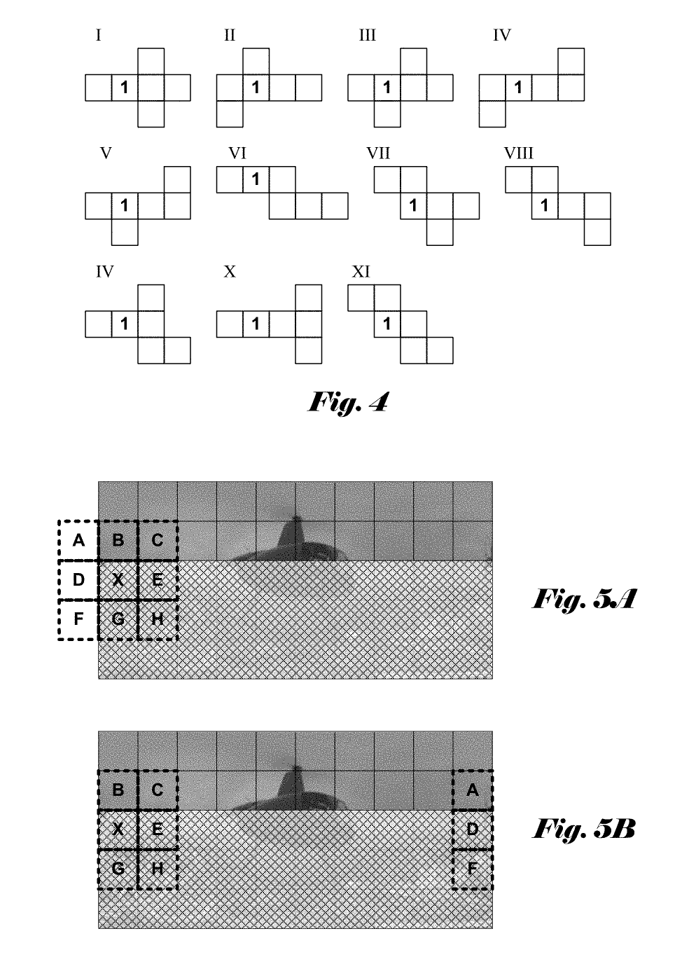

In FIG. 2B and FIG. 2C, two types of cubic frame are illustrated: cubic frame 220 corresponds to a cubic net with blank areas filled with padding data to form a rectangular frame and cubic frame 230 corresponds to six cubic faces assembled without any blank area. For cubic frame corresponding to cubic net with blank areas, the cubic frame can be generated by unfolding the cubic faces into a cubic net consisting of six connected faces. There are 11 distinct cubic nets as shown in FIG. 4, where cube face number 1 is indicated in each cubic net. The cubic frame corresponds to a cubic net with padded blank areas and the cubic frame is formed by fitting the six cubic faces into a smallest rectangular frame that covers these six cubic faces. On the other hand, the six cubic faces are rearranged into a rectangular frame without any blank area. The assembled cubic frame without any blank area for cubic frame 230 represents an assembled 1×6 cubic-face frame. Furthermore, there are other possible types of assembled cubic frames, such as 2×3, 3×2 and 6×1 assembled cubic frames. These assembled forms for cubic faces are also included in this invention.

In conventional video coding using Intra/Inter prediction, the mode information of surrounding coded blocks may be referenced by the current block. The mode information refers to information related coding mode such as Intra prediction mode selected for a current block coded in Intra prediction. The mode information may also correspond to motion vector, associated reference picture list and reference picture index, and prediction direction (e.g., uni-prediction or bi-prediction). Moreover, the reconstructed pixels of surrounding blocks may be also used to generate Intra prediction data for the current block. Due to spatial locality among neighboring blocks, the Intra prediction mode of the current block may be highly correlated to those of the neighboring blocks. Accordingly, the Intra prediction modes of neighboring blocks can be used to form mode prediction to code the current Intra prediction mode. The use of Most Probable Modes (MPM) is a particular way of Intra mode prediction used in HEVC and H.264. In HEVC, three MPMs for the luma Intra prediction while one MPM is used in H.264/MPEG-4 AVC. For HEVC, the first two MPMs are initialized by the luma Intra prediction modes of the left block (i.e., prediction unit, PU) and the above block of the current block if these two neighboring blocks are available and coded using an Intra prediction mode. If the current block is at the left frame boundary, its left neighboring block is considered unavailable according to the conventional video coding. However, according to the present invention, the mode information of the left neighboring block may be available in this case. The detailed derivation and processing of mode information reference are described as follows.

Derivation of Mode Information Reference for Spherical Frames

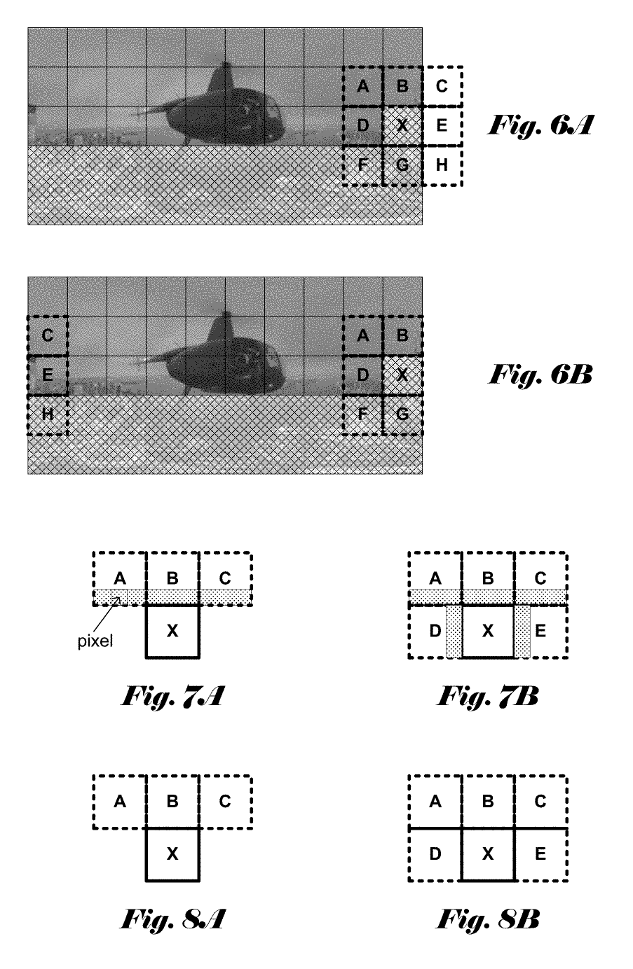

For spherical frames, the contents in each frame are continuous in the horizontal direction. In other words, the left vertical frame boundary is wrapped around to be connected to the right vertical frame boundary. Therefore, some surrounding blocks that are unavailable for a conventional 2D frame may become available for a spherical frame. FIG. 5A illustrates an example of a block X located at the left frame boundary. The picture area that has yet to be coded is shown in crosshatch area. Blocks A through H are surround blocks of block X. For blocks B, C, E, G and H, these blocks are inside the current frame. For blocks A, D and F, these blocks are outside the frame from a conventional 2D frame point of view. Due to the nature of continuity in the horizontal direction, the blocks outside the vertical frame boundary can be remapped to blocks inside the vertical frame boundary on an opposite side according to embodiments of the present invention as shown in FIG. 5B. As shown in FIG. 5B, blocks A, D and F are remapped to the right edge of the spherical frame. FIG. 6A illustrates an example of a block X located at the right frame boundary. The picture area that has yet to be coded is shown in the crosshatch area. Blocks A through H are surround blocks of block X. For blocks A, B, D, F and G, these blocks are inside the current frame. For blocks C, E and H, these blocks are outside the vertical frame boundary from a conventional 2D frame point of view. Due to the nature of continuity in the horizontal direction, the blocks outside the current frame can be remapped to blocks inside the frame according to embodiments of the present invention as shown in FIG. 6B. As shown in FIG. 6B, blocks C, E and H are remapped to the left edge of the spherical frame.

The availability of surrounding blocks can be checked after remapping. For example, after remapping, all blocks become within the frame. For block X at the left edge as shown in FIG. 5B, the blocks including block X and after block X (assuming a block-wise raster scan order being used) as indicated by the crosshatch area are not yet processed. Therefore, blocks A, B and C are available as reconstructed blocks for Intra prediction of block X. For block X at the right edge as shown in FIG. 6B, the blocks including block X and after block X (assuming a block-wise raster scan order being used) as indicated by the crosshatch area are not yet processed. Therefore, blocks A, B, C, D and E are available as reconstructed blocks for Intra prediction of block X.

After the available blocks are determined for Intra prediction, the pixels to be used for Intra prediction can be identified and retrieved from reconstructed pixels in the current frame. For example, for block X at the left edge as shown in FIG. 5B, the reconstructed pixels in blocks A, B and C can be used to generate Intra predictors for block X. In particular, the last pixel line of blocks A, B and C can be used to generate Intra predictors for block X as shown by the dots-filled areas in FIG. 7A. For block X at the right edge as shown in FIG. 6B, the reconstructed pixels in blocks A, B, C, D and E can be used to generate Intra predictors for block X. In particular, the last pixel line of blocks A, B and C, at right edge of block D and at the left edge of block E can be used to generate Intra predictors for block X as shown by the dots-filled areas in FIG. 7B.

As mentioned before, mode information for a current block can be efficiently coded using the mode information of previously coded blocks. For example, the most probable modes (MPM) technique is a form of predictive mode information coding using the mode information of previously coded blocks. In one embodiment, the MPM can be derived from the three available remapped surrounding blocks (i.e., blocks A, B and C) as shown in FIG. 8A for block X at the left frame boundary. For block X at the right frame boundary, the MPM can be derived from the five available remapped surrounding blocks (i.e., blocks A, B, C, D and E) as shown in FIG. 8B for block X at the right frame boundary.

In summary, the surrounding blocks outside frame boundary that are unavailable blocks in the conventional video system may become available after remapping. Therefore, these surrounding blocks that become spatially available after remapping can provide higher prediction efficiency for MPM derivation and Inter predictor generation.

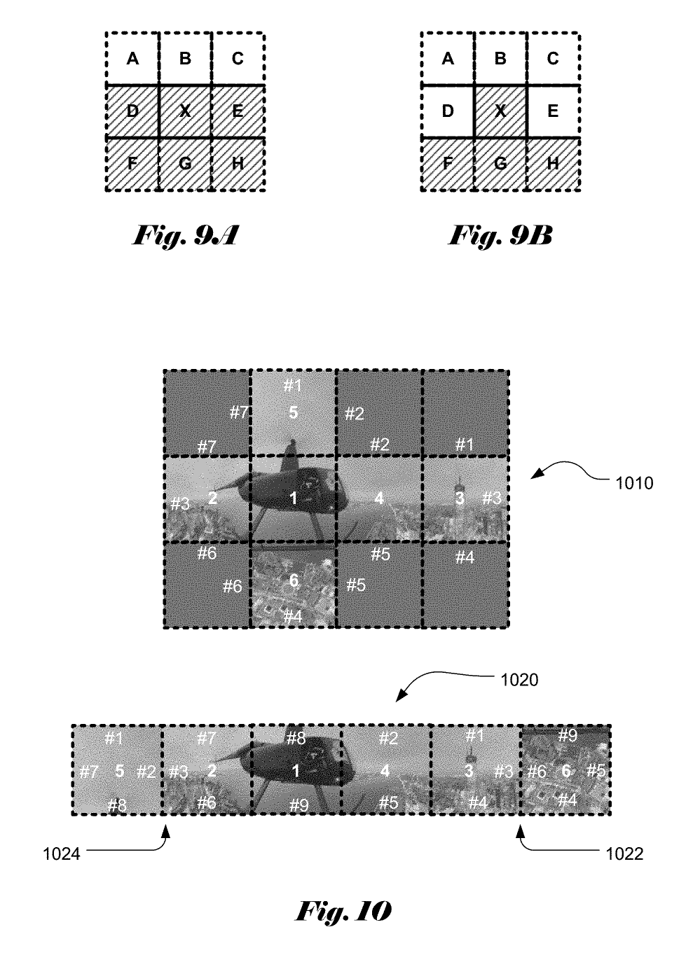

The mode information associated with Inter prediction can also be coded predictively based on mode information of available remapped surrounding blocks. In more recent video coding standards, such as HEVC and AVC/H.264, the mode information (e.g., motion vectors, reference picture list, reference picture index, prediction direction (uni-prediction or bi-prediction)) of spatial and temporal neighboring blocks can be used to derive motion vector predictor (MVP). The spatial neighboring blocks include one or more neighboring blocks in the same frame. The temporal blocks include one or more co-located blocks in a reference frame (i.e., previously coded frame). For example, in FIG. 5B, the spatial neighboring blocks for block X may include available remapped surrounding blocks A, B and C since they are in the same frame and are processed prior to block X. However, for temporal neighboring blocks, the block at the co-located location (i.e., block X) and all of its surrounding blocks (i.e., blocks A through H) are all available. Therefore, any of these blocks in the reference frame can be used as temporal neighboring blocks to derive the mode information for the current block (i.e., block X in the current frame). For example, co-located blocks X, D, E, F, G and H in the reference frame can be used as the temporal neighboring block to derive the mode information for the current block. FIG. 9A illustrates an example of neighboring blocks used to derive mode information for block X at the left edge of the current frame as shown in FIG. 5B, where white blocks (i.e., blocks A, B and C) indicate spatial neighboring blocks and line-filled blocks (i.e., blocks X, D, E, F, G and H) indicate temporal neighboring blocks. For block X at the right edge of current frame in FIG. 6B, the spatial neighboring blocks for block X may include blocks A, B, C, D and E since they are in the same frame and are processed before block X. However, for temporal neighboring blocks, the block at the co-located location (i.e., block X) and all of its surrounding blocks (i.e., blocks A through H) are all available. Therefore, any of these blocks in the reference frame can be used as temporal neighboring blocks to derive the mode information for the current block (i.e., block X in the current frame). For example, blocks X, F, G and H in the reference frame can be used as the temporal neighboring block to derive the mode information for the current block. FIG. 9B illustrates an example of neighboring blocks used to derive mode information for block X at the right edge of the current frame as shown in FIG. 6B, where white blocks (i.e., blocks A, B, C, D and E) indicate spatial neighboring blocks and line-filled blocks (i.e., blocks X, F, G and H) indicate temporal neighboring blocks.

Derivation of Mode Information Reference for Cubic Frames

In FIG. 2B and FIG. 2C, two types of cubic frame are illustrated: cubic frame 220 corresponds to a cubic net with blank areas filled with padding data to form a rectangular frame and cubic frame 230 corresponds to six cubic faces assembled without any blank area. For a cubic frame corresponding to a cubic net with blank areas, the cubic frame can be generated by unfolding the cubic faces into a cubic net consisting of six connected faces. There are 11 distinct cubic nets as shown in FIG. 4. For cubic frames, the cubic faces in each cubic frame can be circularly connected since these cubic faces represent six faces on a cube, where any two neighboring faces are connected at an edge of the cube. In a co-pending U.S. Non-Provisional patent application Ser. No. 15/399,813, filed on Jan. 6, 2017, circular edge labeling in the cubic faces are disclosed, where circular edges at cubic face boundaries are labelled according to the cubic face continuity.

These six cube faces are interconnected in a certain fashion as shown in FIG. 2A. For example, the right side of cubic face 5 is connected to the top side of cubic face 4; and the right side of cubic face 3 is connected to the left side of cubic face 2. Accordingly, the circular edge labeling for the six cubic faces is disclosed in this invention to indicate circular edges at cubic face boundaries (or edges) according to the cubic face continuity. FIG. 10 illustrates examples of the circular edge labeling for the six cubic faces of a cubic frame corresponding to a cubic net with blank areas filled with padding data (1010) and an assembled 1×6 cubic-face frame (1020) without blank areas. Within the assembled 1×6 cubic-face cubic frame, there are two discontinuous cubic-face boundaries (1022 and 1024). For cubic frames, the circular edge labelling is only needed for any non-connected or discontinuous cubic face edge. For connected continuous cubic-face edges (e.g., between bottom edge of cubic face 5 and top edge of cubic face 1 and between the right edge of cubic face 4 and the left edge of cubic face 3), there is no need for circular edge labeling. For convenience, the continuous edge between two connected cubic faces is considered as a continuous part of the cubic faces. In other words, such continuous edge will not be referred as a cubic face boundary. For example, the vertical edge between cubic face 4 and cubic face 3 in cubic frame 1010 and cubic frame 1020 is not referred as cubic face boundary in this disclosure.

With the circular edges labelled, the circular search area can be easily identified according to edges labelled with a same label number. For example, the top edge (#1) of cubic face 5 is connected to the top edge (#1) of cubic face 3. Therefore, access to the reference pixel above the top edge (#1) of cubic face 5 will go into cubic face 3 from its top edge (#1). Accordingly, for circular Inter prediction, when the reference area is outside or crossing a circular edge, the reference block can be located by accessing the reference pixels circularly according to the circular edge labels. Therefore, the reference block for a current block may come from other cubic faces or as a combination of two different cubic faces. Furthermore, for circular edge with the same label, if one edge is in the horizontal direction and the other is in the vertical direction, the reference pixels associated with two different edges need to be rotated to form a complete reference block. For example, reference pixels near the right edge (#5) of cubic face 6 have to be rotated counter-clockwise by 90 degrees before they can be combined with reference pixels near the bottom edge (#5) of cubic face 4. On the other hand, if both edges with the same edge label correspond to top edges or bottom edges of two corresponding cubic faces, the reference pixels associated with two different edges need to be rotated to form a complete reference block. For example, reference pixels near the top edge (#1) of cubic face 5 have to be rotated 180 degrees before they can be combined with reference pixels near the top edge (#1) of cubic face 3.

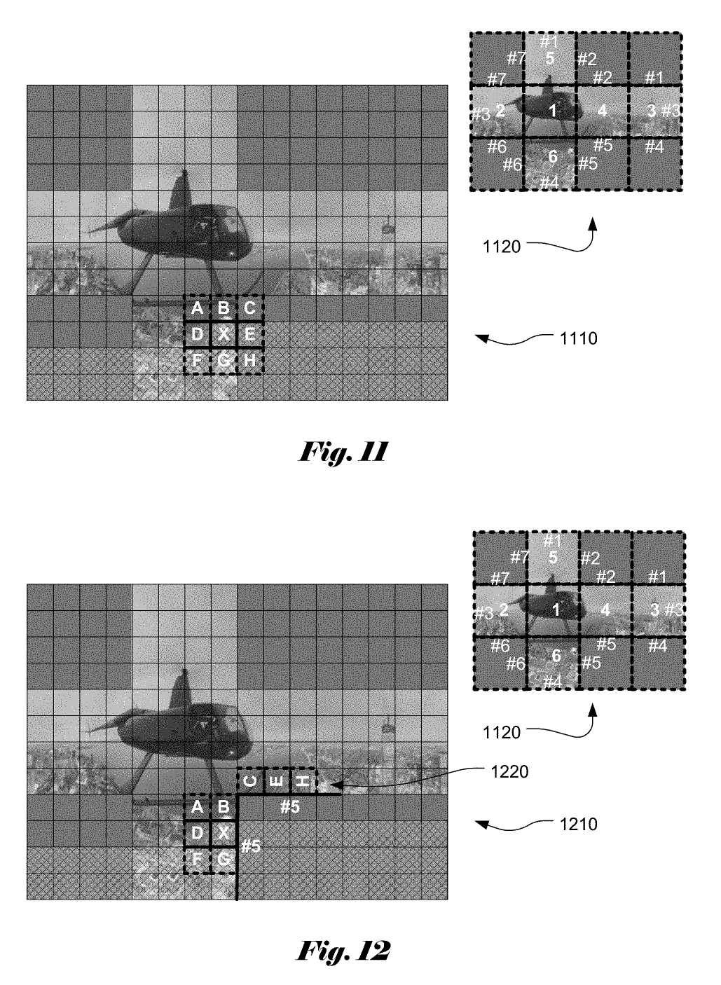

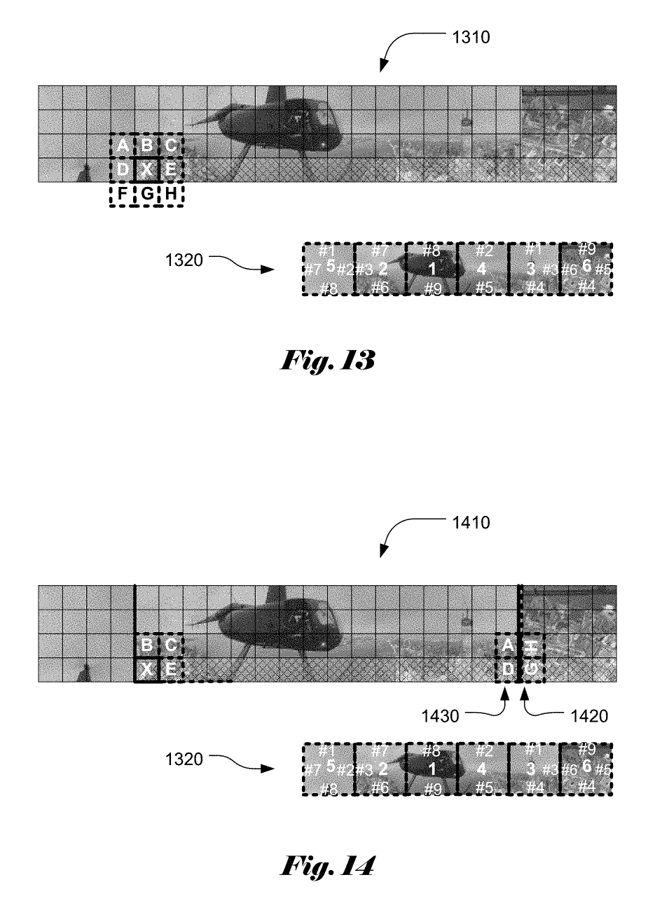

The processing flow for derivation of mode information reference for cubic frames is similar to that for spherical frames. The surrounding blocks for a current block are identified. If a surrounding block is outside a current cubic face, the block is remapped to a connected cubic face that contains the block, where the current cubic face and the connected cubic face is connected at a common edge with the same circular edge label. FIG. 11 illustrates an example of surround blocks for block X located at the edge (i.e., edge #5) of a cubic face (i.e., cubic face 6) of an unfolded cubic frame with blank areas as indicated in illustration 1110, where blocks A through H are surrounding blocks of block X. The circular edge labelling is shown in illustration 1120 for reference. Surrounding blocks C, E and H are outside the cubic face that contains block X. For a conventional 2D frame, the mode information availability of these three blocks would be inaccurate for block X. Therefore, due to continuity in the cubic faces, while blocks C, E and H are outside the cubic face containing block X, these block can be found in a connected cubic face by remapping across a connected edge (i.e., edge #5 in this example) as shown in illustration 1210 of FIG. 12. Furthermore, blocks C, E and H in the cubic face (i.e., cubic face 6) containing block X need to be rotated counter-clockwise by 90 degrees when they are mapped to the connected cubic face (i.e., cubic face 4). The orientation of letters “C”, “E” and “H” (1220) in FIG. 12 indicate the orientation of the blocks with respect to the blocks C, E and H in FIG. 11. In other words, when blocks C, E and H in the connected cubic face (i.e., cubic face 4) are used as surrounding blocks for block X, they needed to be rotated clockwise by 90 degrees first. In FIG. 11 and FIG. 12, the crosshatch areas indicate the blocks that have not been coded yet. In FIG. 12, an example of surrounding block remapping is illustrated for block X at a selected location (i.e., at edge #5 of cubic face 6). The surrounding block remapping can be performed for any other block location according to the circular edge labelling.

FIG. 13 illustrates an example of surround blocks for block X located at the edge (i.e., edge #3 and edge #6) of a cubic face (i.e., cubic face 2) of an assembled cubic frame without blank areas as indicated in illustration 1310, where blocks A through H are surrounding blocks of block X. The circular edge labelling is shown in illustration 1320. Surrounding blocks A, D, F, G and H are outside the cubic face that contains block X. For a conventional 2D frame, the mode information availability of blocks A and D would be inaccurate and blocks F, G, and H are considered to be outside the frame. However, due to continuity in the cubic faces, while blocks A, D, F, G and H are outside the cubic face (i.e., cubic face 2) containing block X, these block can be found in a connected cubic face by remapping across a connected edge. For example, surrounding block G and H below edge #6 can be mapped to blocks at edge #6 of cubic face 6 as shown in illustration 1410 of FIG. 14. Furthermore, blocks G and H in the cubic face containing block X need to be rotated counter-clockwise by 90 degrees when they are mapped to the connected cubic face (i.e., cubic face 6). The orientation of letters “G” and “H” (1420) in FIG. 14 indicate the orientation of the blocks with respect to the blocks G and H in FIG. 13. In other words, when blocks G and H in the connected cubic face are used as surrounding blocks for block X, they needed to be rotated clockwise by 90 degrees first. Surrounding block A and D on the left side of edge #3 can be mapped to blocks (1430) at edge #3 of cubic face 3 as shown in illustration 1410 of FIG. 14. There is no need to rotate the data since they have the same orientation. For surrounding block F, it is remapped to have the same location of the remapped block G. In FIG. 13 and FIG. 14, the crosshatch areas indicate the blocks that have not been coded yet. In FIG. 14, an example of surrounding block remapping is illustrated for block X at a selected location (i.e., at edge #3 and edge #6 of cubic face 2). The surrounding block remapping can be performed for any other block location according to the circular edge labelling.

After surrounding block remapping, the availability of remapped surrounding blocks can be checked. For Intra prediction mode, the remapped surrounding blocks for block X located at an edge (i.e., edge #5) of cubic face 6 in an unfolded cubic frame with blank areas are shown in FIG. 12. A block-wise raster scan order is assumed to process the blocks in the unfolded cubic frame with blank areas. The blocks not yet processed for the current block are indicated by crosshatch. According to FIG. 12, surrounding blocks A, B, C, D, E and H are available and blocks F and G are unavailable. For Intra prediction mode, the remapped surrounding blocks for block X located at an edge (i.e., edge #3) of cubic face 2 in an assembled cubic frame without blank areas are shown in FIG. 14. A block-wise raster scan order is assumed to process the blocks in the unfolded cubic frame with blank areas. The blocks not yet processed for the current block are indicated by crosshatch. According to FIG. 14, surrounding blocks A, B, C and H are available and blocks D, E and G are unavailable, where blocks F and G are remapped to the same location.

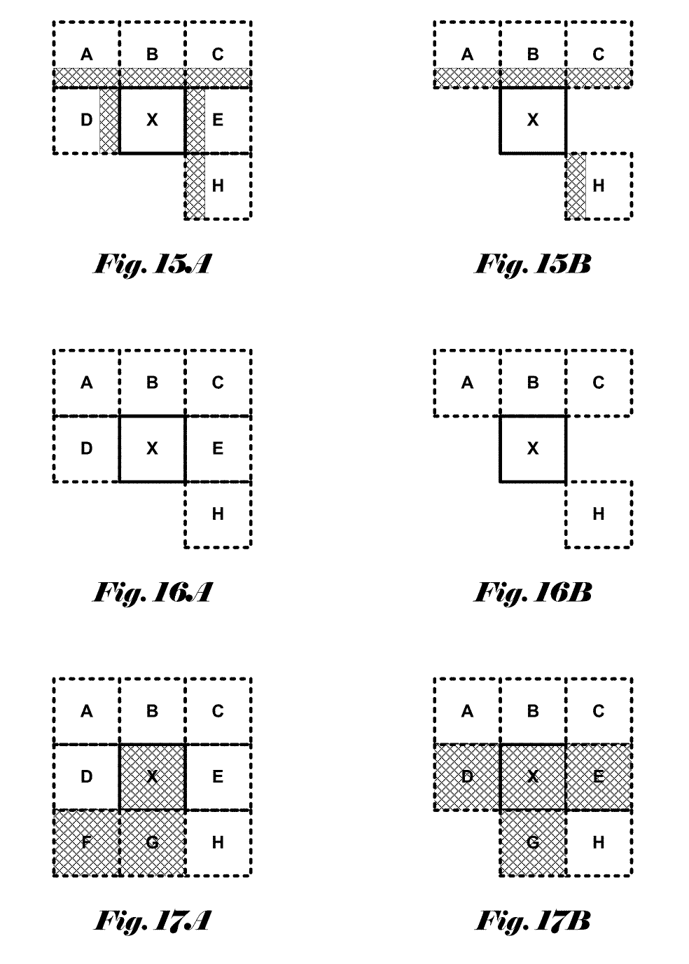

After the available remapped surrounding blocks are identified, the pixels related to these available remapped surrounding blocks can be retrieved to form predictors for the current block. For block X located at edge #5 of cubic face 6 of an unfolded cubic frame with blank areas in FIG. 12, the prediction pixels from the available remapped surrounding blocks is shown in FIG. 15A, where the crosshatch areas indicate the pixels retrieved from the available remapped surrounding blocks. For block X located at the edge (i.e., edge #3 and edge #6) of cubic face 2 of an assembled cubic frame without blank areas in FIG. 14, the prediction pixels from the available remapped surrounding blocks is shown in FIG. 15B, where the crosshatch areas indicate the pixels retrieved from the available remapped surrounding blocks. The areas of prediction pixels in FIG. 15A and FIG. 15B are intended to illustrate an example of prediction pixels. Other areas of prediction pixels may also be used to practice the present invention.

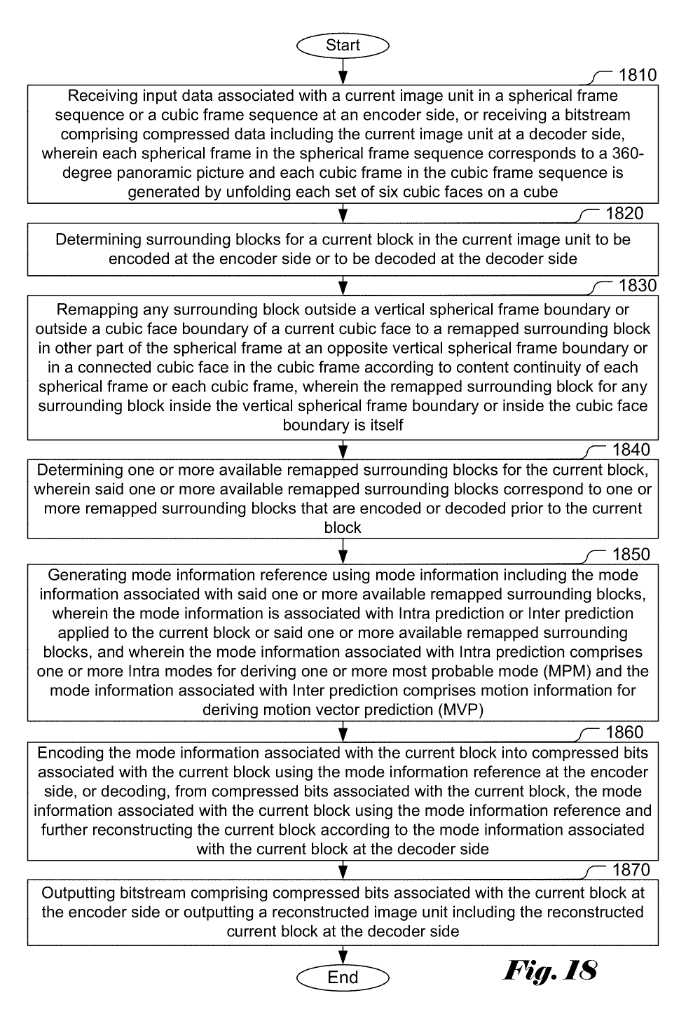

As mentioned before, the mode information of previously coded block can be used to predict current mode information. For example, the Intra prediction mode of neighboring blocks can be used to generate mode prediction (i.e., MPM) for predicting the current Intra prediction mode. For block X located at edge #5 of cubic face 6 of an unfolded cubic frame with blank areas in FIG. 12, the neighboring blocks used to gather Intra prediction modes for generating prediction for Intra prediction mode is shown in FIG. 16A. For block X located at the edge (i.e., edge #3 and edge #6) of cubic face 2 of an assembled cubic frame without blank areas in FIG. 14, the neighboring blocks used to gather Intra prediction modes for generating prediction for Intra prediction mode is shown in FIG. 16B. The neighboring blocks used to gather Intra prediction modes for generating prediction for Intra prediction mode shown in FIG. 16A and FIG. 16B are illustrated as examples for selected block locations. For different block locations, the neighboring blocks used to gather Intra prediction modes for generating prediction for Intra prediction mode may be different.

For Intra prediction, the derivation of mode information for encoding or decoding motion information of a current block is known for conventional 2D video data. For example, in HEVC, most probable mode (MPM) technique is used to generate one or more very likely Intra mode candidates (i.e., MPMs). If the current Intra prediction mode is equal to one of the MPMs, a small number of bits (e.g., one or two bits) can be used to identify the MPM candidate. The present invention addresses the aspects of determining surrounding blocks for spherical frames and cubic frames. In particular, the present invention takes advantage of continuity in the spherical frames and cubic frames. Therefore, some surrounding blocks that would be unavailable if the spherical frames and cubic frames were treated as regular 2D images in a video sequence. However, according to embodiment of the present invention, more surrounding blocks will become available since embodiment of the present invention utilize the continuity of the spherical frames and cubic frames. With more surrounding blocks available, more mode information of surrounding blocks can be used, which can improve the quality of prediction for the current mode information. Accordingly, improved performance can be achieved using embodiments of the present invention.

For Inter prediction, mode information of previously coded blocks can be used to predict or code the mode information of the current block. The previously coded blocks may include spatial neighboring blocks in the reconstructed area of the current frame and temporal neighboring blocks in a reference frame. An example of spatial and temporal neighboring block to derive mode information for block X in FIG. 12 for an unfolded cubic frame with blank areas is described as follows. For spatial neighboring blocks, the available remapped surrounding blocks in the same cubic frame can be used. In other words, blocks A, B, C, D, E and H can be used as spatial neighboring block to derive mode information for coding the mode information of the current block. For blocks X, F and G, these blocks are not yet coded in the current cubic frame. According to this example, the co-located blocks E, F and G in a reference cubic frame (e.g., a previous frame) can be used as temporal neighboring blocks to derive mode information for coding the mode information of the current block. The spatial and temporal neighboring blocks to derive mode information for coding the mode information of the current block (i.e., block X in FIG. 12) are shown in FIG. 17A, where white blocks correspond to spatial neighboring blocks and the crosshatch blocks correspond to temporal neighboring blocks (i.e., co-located blocks). An example of spatial and temporal neighboring block to derive mode information for block X in FIG. 14 for an assembled cubic frame without blank areas is described as follows. For spatial neighboring blocks, the available remapped surrounding blocks in the same cubic frame can be used. In other words, blocks A, B, C and H can be used as spatial neighboring block to derive mode information for coding the mode information of the current block. For blocks X, D, E and G (blocks F and G being remapped to the same location), these blocks are not yet coded in the current cubic frame. According to this example, the co-located blocks X, D, E and G in a reference cubic frame (e.g., a previous frame) can be used as temporal neighboring blocks to derive mode information for coding the mode information of the current block. The above examples of spatial and temporal neighboring blocks for deriving mode information are illustrated for selected blocks. The spatial and temporal neighboring blocks for a current block at other locations may be different. The spatial and temporal neighboring blocks to derive mode information for coding the mode information of the current block (i.e., block X in FIG. 14) are shown in FIG. 17B, where white blocks correspond to spatial neighboring blocks and the crosshatch blocks correspond to temporal neighboring blocks (i.e., co-located blocks).

For Inter prediction, the derivation of motion vector prediction (MVP) for encoding or decoding motion information of a current block is known for conventional 2D video data. For example, in HEVC, an MVP candidate list is generated based on motion information of spatial and temporal neighboring blocks for an intended coding mode (e.g., Merge mode or AMVP (advanced MVP) mode). A same candidate list is maintained at the encoder side and the decoder side. Therefore, an index can be signaled from the encoder to the decoder to indicate the selected candidate. The present invention addresses the aspects of determining surrounding blocks for spherical frames and cubic frames. In particular, the present invention takes advantage of continuity in the spherical frames and cubic frames. Therefore, some surrounding blocks that would be unavailable if the spherical frames and cubic frames were treated as regular 2D images in a video sequence. However, according to embodiment of the present invention, more surrounding blocks will become available since embodiment of the present invention utilize the continuity of the spherical frames and cubic frames. With more surrounding blocks available, more mode information of surrounding blocks can be used, which can improve the quality of prediction for the current mode information. Accordingly, improved performance can be achieved using embodiments of the present invention.

The present invention can be applied to video sequences corresponding to spherical frames or cubic frames. Each spherical frame or cubic frame can be divided into one or more image areas (e.g., slices) for more adaptive processing tailored to local characteristics of the frames or for parallel processing or multiple image areas. For each image area, the processes of identifying surrounding blocks, remapping surrounding blocks that are outside the cubic face of a current block, determining availability of the remapped surrounding blocks, retrieving pixels and mode information of the available remapped surrounding blocks, and deriving mode information prediction can be applied to each current block in the image area.

FIG. 18 illustrates an exemplary flowchart video encoding or decoding for a spherical image sequence or a cubic image sequence in a video encoder or decoder respectively using mode information reference according to an embodiment of the present invention. The flowchart may correspond to the process performed to implement a method according to an embodiment of the present invention. The process may be implemented as program codes executable on a computing device such as a laptop, a smart phone or a portable device. The process may also be performed by electronic circuits or processors such as a programmable logic device or programmable hardware. According to this method, in step 1810, input data associated with a current image unit in a spherical frame sequence or a cubic frame sequence are received at an encoder side, or a bitstream comprising compressed data including the current image unit is received at a decoder side. Each spherical frame in the spherical frame sequence corresponds to a 360-degree panoramic picture and each cubic frame in the cubic frame sequence is generated by unfolding each set of six cubic faces on a cube. The image unit may correspond to a slice. Surrounding blocks for a current block in the current image unit to be encoded at the encoder side or to be decoded at the decoder side are determined in step 1820. Any surrounding block outside a vertical spherical frame boundary or outside a cubic face boundary of a current cubic face is remapped to a remapped surrounding block in other part of the spherical frame at an opposite vertical spherical frame boundary or in a connected cubic face in the cubic frame according to content continuity of each spherical frame or each cubic frame in step 1830, where the remapped surrounding block for any surrounding block inside the vertical spherical frame boundary or inside the cubic face boundary is itself. One or more available remapped surrounding blocks determined for the current block in step 1840, where said one or more available remapped surrounding blocks correspond to one or more remapped surrounding blocks that are encoded or decoded prior to the current block. Mode information reference is generated using mode information including the mode information associated with said one or more available remapped surrounding blocks in step 1850, where the mode information is associated with Intra prediction or Inter prediction applied to the current block or said one or more available remapped surrounding blocks, and wherein the mode information associated with Intra prediction comprises one or more Intra modes for deriving one or more most probable mode (MPM) and the mode information associated with Inter prediction comprises motion information for deriving motion vector prediction (MVP). In step 1860, the mode information associated with the current block is encoded into compressed bits associated with the current block using the mode information reference at the encoder side, or the mode information associated with the current block using the mode information reference is decoded from compressed bits associated with the current block, and the current block is further reconstructed according to the mode information associated with the current block at the decoder side. In step 1870, bitstream comprising compressed bits associated with the current block is outputted at the encoder side or a reconstructed image unit including the reconstructed current block is outputted at the decoder side.

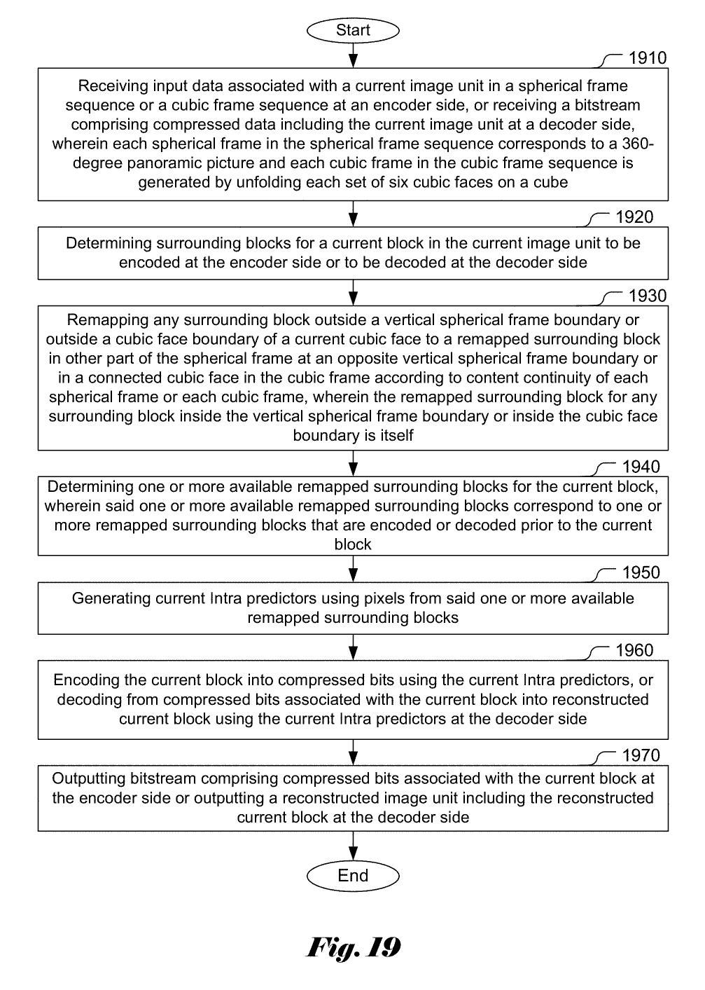

FIG. 19 illustrates an exemplary flowchart video encoding or decoding for a spherical frame sequence or a cubic frame sequence in a video encoder or decoder respectively according to an embodiment of the present invention, where surrounding blocks are remapped to take into consideration of continuity for collecting Intra prediction pixels in Intra prediction. According to this method, in step 1910, input data associated with a current image unit in a spherical frame sequence or a cubic frame sequence are received at an encoder side, or a bitstream comprising compressed data including the current image unit is received at a decoder side. Each spherical frame in the spherical frame sequence corresponds to a 360-degree panoramic picture and each cubic frame in the cubic frame sequence is generated by unfolding each set of six cubic faces on a cube. The image unit may correspond to a slice. Surrounding blocks for a current block in the current image unit to be encoded at the encoder side or to be decoded at the decoder side are determined in step 1920. Any surrounding block outside a vertical spherical frame boundary or outside a cubic face boundary of a current cubic face is remapped to a remapped surrounding block in other part of the spherical frame at an opposite vertical spherical frame boundary or in a connected cubic face in the cubic frame according to content continuity of each spherical frame or each cubic frame in step 1930, where the remapped surrounding block for any surrounding block inside the vertical spherical frame boundary or inside the cubic face boundary is itself. One or more available remapped surrounding blocks determined for the current block in step 1940, where said one or more available remapped surrounding blocks correspond to one or more remapped surrounding blocks that are encoded or decoded prior to the current block. Current Intra predictors are generated using pixels from said one or more available remapped surrounding blocks in step 1950. In step 1960, the current block is encoded into compressed bits using the current Intra predictors, or a reconstructed current block is decoded from compressed bits associated with the current block using the current Intra predictors at the decoder side. In step 1970, bitstream comprising compressed bits associated with the current block is outputted at the encoder side or a reconstructed image unit including the reconstructed current block is outputted at the decoder side.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video encoding or decoding for a spherical image sequence or a cubic image sequence in a video encoder or decoder respectively, the method comprising:
receiving input data associated with a current image unit in a spherical image sequence or a cubic image sequence at an encoder side, or receiving a bitstream comprising compressed data including the current image unit at a decoder side, wherein each spherical image in the spherical image sequence corresponds to a 360-degree panoramic picture and each cubic image in the cubic image sequence is generated by unfolding each set of six cubic faces on a cube;
determining surrounding blocks for a current block in the current image unit to be encoded at the encoder side or to be decoded at the decoder side;
remapping any surrounding block outside a spherical frame boundary or outside a cubic face boundary of a current cubic face to a remapped surrounding block in other part of the spherical image at another spherical frame boundary or in a connected cubic face in the cubic image according to content continuity of each spherical image or each cubic image, wherein the remapped surrounding block for any surrounding block inside the spherical frame boundary or inside the cubic face boundary is itself;
determining one or more available remapped surrounding blocks for the current block, wherein said one or more available remapped surrounding blocks correspond to one or more remapped surrounding blocks that are encoded or decoded prior to the current block;
generating mode information reference using mode information including the mode information associated with said one or more available remapped surrounding blocks, wherein the mode information is associated with Intra prediction or Inter prediction applied to the current block or said one or more available remapped surrounding blocks, and wherein the mode information associated with Intra prediction comprises one or more Intra modes for deriving one or more most probable mode (MPM) and the mode information associated with Inter prediction comprises motion information for deriving motion vector prediction (MVP);
encoding the mode information associated with the current block into compressed bits associated with the current block using the mode information reference at the encoder side, or decoding, from compressed bits associated with the current block, the mode information associated with the current block using the mode information reference and further reconstructing the current block according to the mode information associated with the current block at the decoder side; and
outputting bitstream comprising compressed bits associated with the current block at the encoder side or outputting a reconstructed image unit including the reconstructed current block at the decoder side.

2. The method of claim 1, wherein when the current block is located at a left frame boundary of a spherical image, one or more surrounding blocks to a left edge of the current block are horizontally mapped to a right frame boundary of the spherical image.

3. The method of claim 1, wherein when the current block is located at a right frame boundary of a spherical image, one or more surrounding blocks to a right edge of the current block are horizontally mapped to a left frame boundary of the spherical image.

4. The method of claim 1, wherein when the current block is located at a current cubic face boundary of a cubic image, one or more surrounding blocks outside the cubic face are circularly mapped to one or more connected cubic faces, wherein each connected cubic face is connected to the current cubic face at a common circular edge having a same circular edge labelling.

5. The method of claim 1, wherein if the mode information is associated with the Intra prediction applied to the current block or said one or more available remapped surrounding blocks, the mode information reference corresponds to most probable modes (MPM).

6. The method of claim 1, wherein if the mode information is associated with the Intra prediction applied to the current block or said one or more available remapped surrounding blocks, the mode information reference corresponds to Intra prediction pixels with one or more available remapped surrounding blocks.

7. The method of claim 1, wherein if the mode information is associated with the Inter prediction applied to the current block or said one or more available remapped surrounding blocks, the mode information reference corresponds to motion vector prediction (MVP).

8. The method of claim 7, wherein the mode information includes motion vector, reference picture list, reference picture index or a combination thereof.

9. The method of claim 7, wherein said one or more available remapped surrounding blocks are used as spatial neighboring blocks and co-located blocks of one or more unavailable remapped surrounding blocks are used as temporal neighboring blocks for deriving the MVP.

10. The method of claim 9, wherein an MVP candidate list is generated using motion information associated with the spatial neighboring blocks and the temporal neighboring blocks.

11. An apparatus for video encoding or decoding of a spherical image sequence or a cubic image sequence at a video encoder side or decoder side respectively, the apparatus comprising one or more electronic circuits or processors arranged to:
receive input data associated with a current image unit in a spherical image sequence or a cubic image sequence at an encoder side, or receiving a bitstream comprising compressed data including the current image unit at a decoder side, wherein each spherical image in the spherical image sequence corresponds to a 360-degree panoramic picture and each cubic image in the cubic image sequence is generated by unfolding each set of six cubic faces on a cube;
determine surrounding blocks for a current block in the current image unit to be encoded at the encoder side or to be decoded at the decoder side;
remap any surrounding block outside a spherical frame boundary or outside a cubic face boundary of a current cubic face to a remapped surrounding block in other part of the spherical image at another spherical frame boundary or in a connected cubic face in the cubic image according to content continuity of each spherical image or each cubic image, wherein the remapped surrounding block for any surrounding block inside the spherical frame boundary or inside the cubic face boundary is itself;
determine one or more available remapped surrounding blocks for the current block, wherein said one or more available remapped surrounding blocks correspond to one or more remapped surrounding blocks that are encoded or decoded prior to the current block;
generate mode information reference using mode information including the mode information associated with said one or more available remapped surrounding blocks, wherein the mode information is associated with Intra prediction or Inter prediction applied to the current block or said one or more available remapped surrounding blocks, and wherein the mode information associated with Intra prediction comprises one or more Intra modes for deriving one or more most probable mode (MPM) and the mode information associated with Inter prediction comprises motion information for deriving motion vector prediction (MVP);
encode the mode information associated with the current block into compressed bits associated with the current block using the mode information reference at the encoder side, or decoding, from compressed bits associated with the current block, the mode information associated with the current block using the mode information reference and further reconstructing the current block according to the mode information associated with the current block at the decoder side; and
output bitstream comprising compressed bits associated with the current block at the encoder side or outputting a reconstructed image unit including the reconstructed current block at the decoder side.

12. A method of video encoding or decoding using Intra prediction for a spherical image sequence or a cubic image sequence in a video encoder or decoder respectively, the method comprising:
receiving input data associated with a current image unit in a spherical image sequence or a cubic image sequence at an encoder side, or receiving a bitstream including compressed data including the current image unit at a decoder side, wherein each spherical image in the spherical image sequence corresponds to a 360-degree panoramic picture and each cubic image in the cubic image sequence is generated by unfolding each set of six cubic faces on a cube;
determining surrounding blocks for a current block in the current image unit to be encoded at the encoder side or to be decoded at the decoder side;
remapping any surrounding block outside a spherical frame boundary or outside a cubic face boundary of a current cubic face to a remapped surrounding block in other part of the spherical image at another spherical frame boundary or in a connected cubic face in the cubic image according to content continuity of each spherical image or each cubic image, wherein the remapped surrounding block for any surrounding block inside the spherical frame boundary or inside the cubic face boundary is itself;
determining one or more available remapped surrounding blocks for the current block, wherein said one or more available remapped surrounding blocks correspond to one or more remapped surrounding blocks that are encoded or decoded prior to the current block;
generating current Intra predictors using pixels from said one or more available remapped surrounding blocks;
encoding the current block into compressed bits using the current Intra predictors, or decoding from compressed bits associated with the current block into reconstructed current block using the current Intra predictors at the decoder side; and
outputting bitstream comprising compressed bits associated with the current block or outputting a reconstructed image unit including the reconstructed current block at the decoder.

13. The method of claim 12, wherein the current image unit corresponds to a slice.

14. The method of claim 12, wherein when the current block is located at a left frame boundary of a spherical image, one or more surrounding blocks to a left edge of the current block are horizontally mapped to a right frame boundary of the spherical image.

15. The method of claim 12, wherein when the current block is located at a current cubic face boundary of a cubic image, one or more surrounding blocks outside the cubic face are circularly mapped to one or more connected cubic faces, wherein each connecting cubic face is connected to the current cubic face at a common circular edge having a same circular edge labelling.

16. An apparatus for video encoding or decoding of a spherical image sequence or a cubic image sequence using Intra prediction at a video encoder side or decoder side respectively, the apparatus comprising one or more electronic circuits or processors arranged to:
receive input data associated with a current image unit in a spherical image sequence or a cubic image sequence at an encoder side, or receiving a bitstream including compressed data including the current image unit at a decoder side, wherein each spherical image in the spherical image sequence corresponds to a 360-degree panoramic picture and each cubic image in the cubic image sequence is generated by unfolding each set of six cubic faces on a cube;
determine surrounding blocks for a current block in the current image unit to be encoded at the encoder side or to be decoded at the decoder side;
remap any surrounding block outside a spherical frame boundary or outside a cubic face boundary of a current cubic face to a remapped surrounding block in other part of the spherical image at another spherical frame boundary or in a connected cubic face in the cubic image according to content continuity of each spherical image or each cubic image, wherein the remapped surrounding block for any surrounding block inside the spherical frame boundary or inside the cubic face boundary is itself;
determine one or more available remapped surrounding blocks for the current block, wherein said one or more available remapped surrounding blocks correspond to one or more remapped surrounding blocks that are encoded or decoded prior to the current block;
generate current Intra predictors using pixels from said one or more available remapped surrounding blocks;
encode the current block into compressed bits using the current Intra predictors, or decoding from compressed bits associated with the current block into reconstructed current block using the current Intra predictors at the decoder side; and
output bitstream comprising compressed bits associated with the current block or outputting a reconstructed image unit including the reconstructed current block at the decoder.
